(19) United States
(12) Patent Application Publication
(10) Pub. No.: US 2026/0010764 A1
(43) Pub. Date: Jan. 8, 2026

(54) UNIVERSAL CROSS-DOMAIN RECOMMENDATION METHOD BASED ON PREFERENCE PROTOTYPE-AWARE LEARNING

(71) Applicant: Nanjing University of Aeronautics and Astronautics, Jiangsu (CN)

(72) Inventors: Yuxi ZHANG, Jiangsu (CN); Ji ZHANG, Jiangsu (CN); Bohan LI, Jiangsu (CN); Feiyang XU, Jiangsu (CN); Lvying CHEN, Jiangsu (CN)

(73) Assignee: Nanjing University of Aeronautics and Astronautics, Jiangsu (CN)

(21) Appl. No.: 19/187,880

(22) Filed: Apr. 23, 2025

(30) Foreign Application Priority Data
Jul. 4, 2024 (CN) 202410894895.1

(51) Int. Cl. G06N 3/0455; G06F 16/9535

(52) U.S. Cl. CPC G06N 3/0455; G06F 16/9535

(57) ABSTRACT

A universal recommendation method based on preference prototype-aware learning, which belongs to the big data analysis technologies. The present disclosure, when realizing the universal cross-domain recommendation, quantitatively learns the user preference through a preference prototype-aware learning method while minimizing interference from the source domain. The method of the present disclosure consists of two complementary components: a hybrid encoder and a preference prototype-aware decoder, which form an end-to-end unified framework suitable for various real-world scenarios. The hybrid encoder uses a hybrid network to learn general representations of interactive items and capture the intrinsic relationships between items across different domains. The preference prototype-aware decoder implements a learnable prototype matching mechanism to quantitatively perceive user preferences and can accurately capture user preferences at a higher semantic level. The preference prototype-aware decoder can also avoid interference caused by item features from the source domain.

### CROSS-REFERENCE TO RELATED APPLICATION

This application claims the priority benefit of China application serial no. 202410894895.1, filed on Jul. 4, 2024. The entirety of the above-mentioned patent application is hereby incorporated by reference herein and made a part of this specification.

### BACKGROUND

### Technical Field

The present disclosure belongs to the technical field of big data analysis, specifically relates to information recommendation technologies, and particularly relates to a universal cross-domain recommendation method based on preference prototype-aware learning.

### Description of Related Art

Recommendation technologies aim to provide a satisfactory information push service for users and are widely applied to numerous online scenarios, such as friend recommendations on social software, commodity recommendations on a shopping platform, and video recommendations on a short video platform. Recommendation systems drastically change the way users discover and engage with content, primarily by exploring potential user preferences and suggesting items that may be of interest. The single intra-domain recommendation system focuses on modeling the behaviors of a user in one domain. It generates recommendation results by analyzing the historical behaviors of the user and the features of articles and continuously optimizes the recommendation effect, such that personalized recommendations related to the user are provided to meet the preferences and the requirements of the user.

Cross-domain recommendations enhance the understanding of user preferences by utilizing data from multiple domains and thereby enable more personalized and accurate recommendations. Conventional recommendation systems mainly focus on dual-domain research and lack an independent special module for user preference modeling. In attempts to extract user preferences across multiple domains, these methods face challenges in identifying true user preferences and filtering redundant item features, making them less than satisfactory in such situations. To address these issues, specialized modules are constructed in some methods to extract user preferences. These methods are based on a unified framework and are thereby convenient for application in dual-domain and multi-domain real-world scenarios, and are therefore classified as universal cross-domain recommendation methods. This pioneering work is to capture specific features of an item through an aggregator, which consists of only simple pooling or attention mechanisms. Inspired by this universal and effective framework, some methods re-transmit user preferences using fine-tuning techniques. However, this method requires pre-training, fails to form an end-to-end structure, and cannot directly extract user preferences. Recently, some methods have aimed at encouraging models to indirectly predict user preferences by masking the user preferences extracted by the item representations. A crucial limitation of this method is that the masking mechanism is more challenging for datasets that are insufficient in data volume.

Despite the promising outcomes, the above cross-domain recommendation research has focused primarily on extracting user preferences and specific features from the source domain. However, this method may not effectively capture the true essence of user preferences, as they are more closely related to items that interact at a higher semantic level, rather than specific item features. Overemphasizing specific features of items may result in sub-optimal recommendations and discourage shifting of user preferences across domains. If only specific features of books, such as author, type, or style of writing, are considered, there may be too narrow attention being paid to features associated with the books. Particularly when the items are related to the user's preference for comedy, this item feature-centered method may make it challenging to recommend related items in other areas (such as movies or television programs) that are aligned with the user's preferences. Dependency on specific item features may introduce noise and limit the generalization ability of recommendation systems. All of these methods use specific item features to roughly represent user preferences, ignoring the significant interference of source domain features and irrelevant specific features. This neglect results in an ultimately sub-optimal recommendation that is based on redundant specific features, as the model cannot effectively distinguish between effective features and irrelevant features.

### SUMMARY

To overcome the defects of extracting redundant features in the prior art, the present disclosure provides a universal recommendation method based on preference-aware learning, which can better learn general representation of interactive items, capture the inherent relationships between items in different domains, and realize accurate extraction of user preferences, thereby realizing better recommendation effect.

Provided is a universal cross-domain recommendation method based on preference prototype-aware learning. The method includes: quantifying user preferences through prototype-aware learning and realizing universal cross-domain recommendations under several scenarios according to given specific interactive items, global interactive items, and user IDs, and the implementation steps of the method include:
S1, defining users, items, and interactions in domains, where a dual-domain scenario composed of an X domain and a Y domain is expressed as i∈{X, Y}, a set of users, items, and interactions is expressed as [symbol] =( [symbol] , [symbol] , [symbol] ), and a similarity score between cross-domain items is expressed as B_{g}=(B^{X}, B^{Y}), where B^{X} and B^{Y} represent personalized similarity scores in the X domain and the Y domain, respectively, and the similarity scores are used for enhancing prior knowledge of item features;

based on an interaction [symbol] , N items are selected from items [symbol] to constitute a specific interactive item Vₛⁱ; based on the interaction [symbol] , 2N items are selected from [symbol] and [symbol] to represent a shared interactive item V_{g}; Vₛⁱ and Bⁱ, as well as global embeddings V_{g} and Bg, constitute effective item-related inputs;
S2, extracting effective specific representations through guidance of item scores to construct a hybrid encoder, learning universal representations of interacted items based on a hybrid network, and capturing two encoded domain features via two hybrid encoder branches, so as to capture deeper level dependencies between items and generate learnable weights through the item scores to guide item embedding;
S3, based on the relationship between items captured by the hybrid network in the step S2, encoding a specific branch and a global branch into a specific domain feature and a global domain feature that are highly relevant, then learning representations of a specific domain and a global domain by using the hybrid encoder, and providing the representations and encoded features of the specific branch and the global branch for a prototype-aware decoder; and
S4, using a user interest prototype quantified by the prototype decoder to locate a target item, including performing dislike-to-like quantification on user preferences in a source domain according to a positive preference and a negative preference, thereby obtaining a prototype preference representation; calculating item similarity based on the prototype-aware decoder, and introducing preferences of the source domain into a shared domain to guide a global encoded feature [symbol] to realize extraction of a final user feature from a target domain; and finally determining a recommended item through calculation of user-item prediction scores through Sₚ= [symbol] ·vᵢ;

the method includes adopting contrastive learning as an auxiliary task algorithm to adjust potential space of positive and negative interactions.

Based on the above solution, further, the step S1 further includes the following step:

defining [symbol] − [symbol] and [symbol] ∈ [symbol] as embeddings of users and items, respectively, for extracting effective representations, where h is a global embedding dimension, u represents an embedding of a data user, and three basic representations, u, (Vₛⁱ, Bⁱ), and (V_{g}, B_{g}), that are capable of being applied to cross-domain recommendation in a multi-target scenario are obtained based on the embedding layer, where u represents a user embedding, vₛⁱ represents a specific item embedding with score Bⁱ, and v_{g} represents a global item embedding with score B_{g}.

Further, in the step S2, considering interaction behaviors of a potential user uⱼ within an X domain, the hybrid network is designed based on history records containing a specific item embedding Vₛ^{X}∈R^{N×h} and a score B^{X}∈R^{N×1} to capture a domain representation E, and the hybrid network is used for compressing item embeddings and scores, where N is a sample volume;

the hybrid network encodes item embeddings through a parameter Ψ, and the encoding is expressed as ƒ(·; Ψ):R^{N×h}→R^{1×h}; the hybrid network follows the following mixing mechanism:

$${W}_{1} , {W}_{2} = \vert [ {{W}_{θ}}_{1} , {{W}_{θ}}_{2} ] \cdot B \vert ,$$

$$E = {W}_{2}^{Τ} \cdot ReLU ( {W}_{1}^{Τ} \cdot v ) ,$$

$$ℱ = E + {u}_{j} ,$$

where, W_{θ}_{₁} and W_{θ}_{₂} are learnable parameters, a symbol |·| represents taking an absolute value, and mixing weights W₁∈R^{N×h} and W₂∈R^{h×1} are obtained by learning based on an input score B; after executing the above formula, a final encoded domain feature [symbol] ∈R^{1×h} is generated through a domain representation E and a current user embedding uⱼ.

Further, in the step S3, the specific branch refers to feeding an input [symbol] to the hybrid encoder to capture a potential specific feature, and the specific feature is expressed as follows:

$${ℱ}_{𝓈} = f ( [ {u}_{j} , ( {v}_{s}^{X} , {B}^{X} ) ] ; {ψ}_{s} ) ∈ {R}^{1 \times h}$$

the global branch refers to feeding an input [uⱼ, (v_{g}, B_{g})] to the hybrid encoder to generate a global encoded feature, and the global encoded feature is expressed as follows:

$${ℱ}_{ℊ} = f ( [ {u}_{j} , ( {v}_{g} , {B}_{g} ) ] ; {ψ}_{g} ) ∈ {R}^{𝕝 \times h}$$

in this step, the encoded features [ [symbol] , [symbol] ] will be further used by the decoder.

Further, in the step S4, the quantification of the user preferences in the source domain is dividing the positive preference into K adjustable prototypes and dividing the negative preferences into K prototypes and thereby enabling quantification of preferences, ranging from dislike to like

the above prototypes are expressed as [symbol] ={p₁, p₂, . . . , p_{2K}|pᵢ∈R^{1×h}}, and as the user preferences are extracted from the source domain, the prototypes interact only with [symbol] , so a model is allowed to perceive preferences by matching with a prototype p* with a highest similarity, and the similarity is calculated as follows:

$$sim ( {𝓅}_{i} , {ℱ}_{𝓈} ) = log ( \frac{{‖ {𝓅}_{i} - {ℱ}_{𝓈} ‖}_{2}^{2} + 1}{{‖ {𝓅}_{i} - {ℱ}_{𝓈} ‖}_{2}^{2} + ϵ} )$$

where, ϵ is set to a small value to prevent division by zero; after the preference prototype p* is obtained, such preferences of the source domain are introduced into the shared domain to guide the global encoded feature [symbol] , thereby effectively extracting the final user feature [symbol] from the target domain, where a linear layer gᵤ is provided with a parameter ϕ used for dynamically adapting the encoded feature to continuously changing preference features and extracting the final user feature:

$${ℱ}_{𝓊} = {g}_{u} ( {ℱ}_{ℊ} , {p}^{*} ; ϕ ) ∈ {R}^{1 \times h}$$

an objective function [symbol] of prototype learning is defined as follows:

$${ℒ}_{𝓅ℓ} = {ℒ}_{𝒸ℯ} ( c ∘ {g}_{p} ∘ {ℱ}_{𝓈} , l ) + {λ}_{1} {ℒ}_{𝒸ℓ𝓈𝓉} + {λ}_{2} {ℒ}_{𝓈ℯ𝓅} + {λ}_{3} {ℒ}_{𝒹𝒾𝓋}$$

where, c denotes a fully connected layer and is used for predicting probability of being positive or negative, gₚ is a prototype layer, [symbol] represents cross-entropy loss for preference classification within a prototype branch, l is an array for distinguishing item types, and λ₁, λ₂, λ₃ are weights for controlling loss;

to construct a final prototype, constraints considered include:
(1) setting a clustering loss [symbol] to encourage these interactive items of the source domain to approach a prototype corresponding to preferences thereof;

$${ℒ}_{𝒸ℓ𝓈𝓉} = \frac{1}{n} {\sum }_{i = 1}^{2 K} {min}_{j : {p}_{j} ∈ {𝒫}_{{𝓎}_{𝒾}}} {‖ {ℱ}_{𝓈} - {p}_{j} ‖}_{2}^{2}$$

(2) setting a separation loss [symbol] to facilitate an increase in a distance between an encoded item feature and a prototype that does not belong to preferences thereof; and

$${ℒ}_{𝓈ℯ𝓅} = - \frac{1}{n} {\sum }_{i = 1}^{2 K} {min}_{j : {p}_{j} ∉ {𝒫}_{{𝓎}_{𝒾}}} {‖ {ℱ}_{𝓈} - {p}_{j} ‖}_{2}^{2}$$

(3) setting a diversity loss [symbol] to encourage diversity in learned prototypes by punishing overly similar prototypes;

$${L}_{𝒹𝒾𝓋} = {\sum }_{k = 1}^{2} {\sum }_{{i \neq j}_{{p}_{i} , {p}_{j} ∈ {𝒫}_{𝓀}}} max ( 0 , cos ( {p}_{i} , {p}_{j} ) - ξ )$$

in the above formula, [symbol] is a set of prototypes under class [symbol] , k={1, 2} represents two preferences, and ξ is a threshold for cosine similarity in the diversity loss;

finally, the user-item prediction score is calculated through Sₚ= [symbol] ·vᵢ to determine the recommended item;

the method also uses binary cross-entropy loss to make a prediction of loss:

$${ℒ}_{{𝓅𝓇ℯ𝒹}^{}} = {\sum }_{( u , v ) ∈ ε} [ - log {S}_{p} - log ( 1 - {S}_{n} ) ]$$

where, a negative prediction score of an uninterested item v̅ⁱ is calculated through a dot product operation Sₙ= [symbol] ·v̅ⁱ.

Further, specific steps of adopting the contrastive learning as the auxiliary task algorithm to adjust the potential space of the positive and negative interactions are as follows:

assuming that on a K domain, a positive input is the same as a specific item Vₛ^{X} on a primary branch, and a negative input is randomly sampled from uninterested items V̅ₛ^{X}; after the primary branch, a positive feature [symbol] =PPA(Vₛ^{X}) and a negative feature [symbol] =PPA(V̅ₛ^{X}) are obtained, and an auxiliary loss is as follows:

$${ℒ}_{𝒸ℓ}^{𝒳} = {\sum }_{u ∈ {𝒰}^{𝒳}} [ {ℒ}_{ce} ( {F}_{𝓅} , {Z}_{p} ) + {ℒ}_{𝒸ℯ} ( {ℱ}_{𝓃} , {Z}_{n} ) ]$$

in the formula, [symbol] represents cross-entropy loss for classification, Zₚ is a positive label and represents 1, and Zₙ is a negative label and represents 0;

a model constructed by the method is optimized through the following overall objective function [symbol] :

$${ℒ}_{𝓉ℴ𝓉} = {ℒ}_{𝓅𝓇ℯ𝒹} + {λ}_{𝓅ℓ} {ℒ}_{𝓅ℓ} + {ℒ}_{c ℓ} .$$

Beneficial effects: The remarkable effects of the universal cross-domain recommendation method based on preference prototype-aware learning provided by the present disclosure are as follows:
(1) The present disclosure redesigns the extraction of user preferences, conducts experiments on the problem of interference of redundant item features in item feature-centered extraction in the source domain, and can more accurately capture the real preferences of users.
(2) The present disclosure, by mining the user preference from quantitative prototypes, can minimize item interference while learning accurate user preferences.
(3) The present disclosure can effectively capture user preferences under a variety of scenarios in a unified end-to-end framework by integrating a hybrid encoder and a prototype decoder.

### BRIEF DESCRIPTION OF THE DRAWINGS

FIG. 1A is a schematic diagram of a flowchart of a conventional method;

FIG. 1B is a schematic diagram of a framework of the method of the present disclosure; and

FIG. 2 is a schematic diagram of an overall structure of the model of the present disclosure.

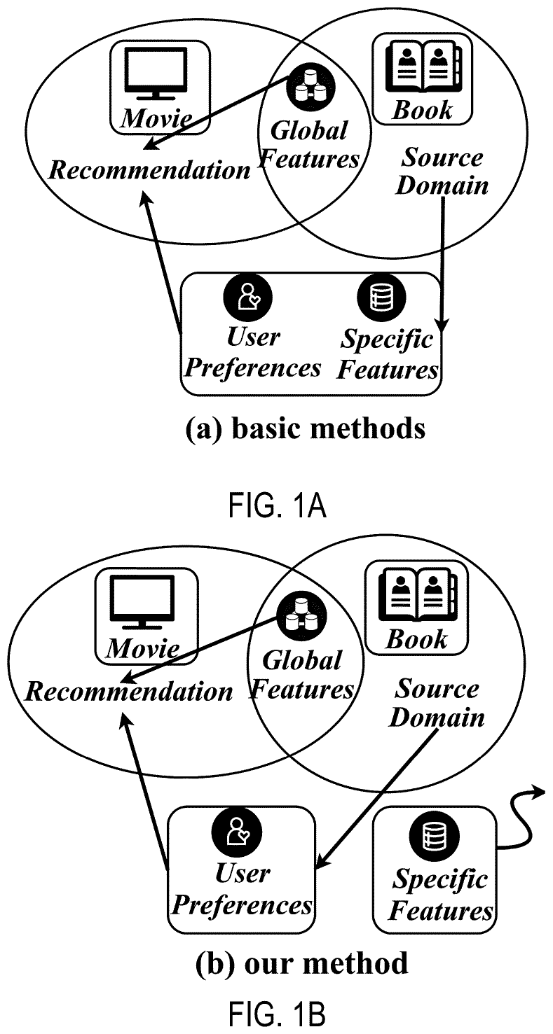

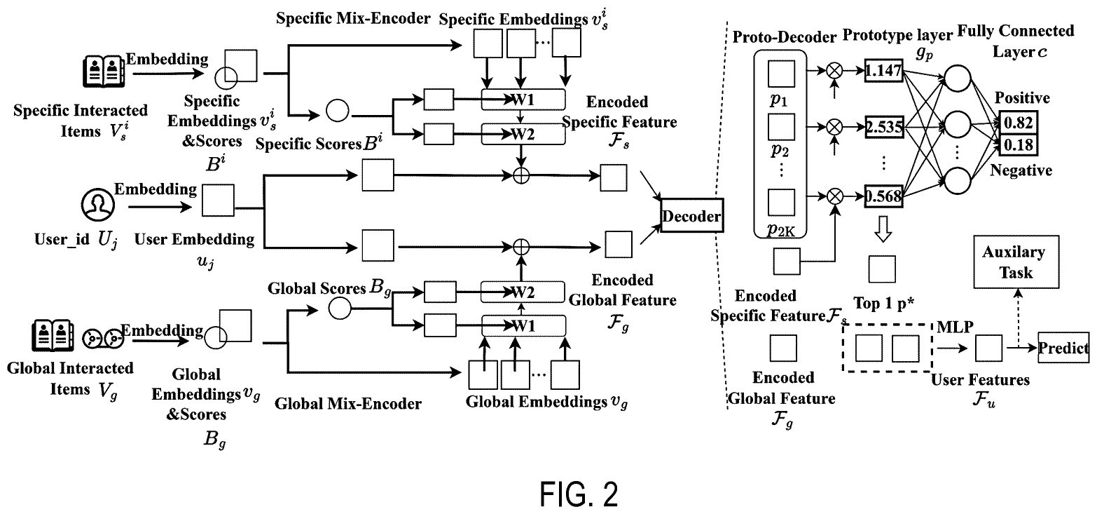

### DESCRIPTION OF THE EMBODIMENTS

To better understand the above technical solution, the above technical solution is described in detail below with reference to the drawings of the specification and specific embodiments.

The present disclosure provides a universal recommendation method based on preference-aware learning, which aims to better learn general representation of interactive items, capture intrinsic relationships between items across different domains, and realize accurate extraction of user preferences, thereby realizing better recommendation effect. The method mainly includes the following implementation steps.

Step 1, users, items, and interactions are defined in domains.

For a dual-domain scenario i∈{X, Y}, the recommendation data consists of users, items, and interactions and is expressed as [symbol] =( [symbol] , [symbol] , [symbol] ). For the interaction [symbol] , the present disclosure calculates pre-processed item-item similarity through B_{g}=(B^{X}, B^{Y}). B^{X}∈R^{|v}^{^{X}}^{|×1} represents the personalized item score in the X domain, and B^{Y} represents the personalized item score in the Y domain. These similarity scores are used for enhancing the priori knowledge of item features.

The present disclosure selects, based on [symbol] , N items from [symbol] to represent a specific interactive item [symbol] . The present disclosure selects, based on [symbol] , 2N items from [symbol] and [symbol] to represent a shared interactive item V_{g}. Vₛⁱ and Bⁱ, as well as V_{g} and B_{g}, constitute effective item-related inputs. To further extract effective representation thereof, the present disclosure introduces [symbol] ∈ [symbol] and [symbol] ∈ [symbol] to represent the embeddings of users and items, respectively, where h is the global embedding dimension. After these embedding layers, three basic representations of the cross-domain recommendation are obtained, namely the user embedding u, the specific item embedding [symbol] with score Bⁱ, and the global item embedding v_{g} with score B_{g}. The present disclosure introduces u, (Vₛⁱ, Bⁱ), and (V_{g}, B_{g}), Vₛⁱ and Bⁱ, as well as V_{g} and B_{g}, in a multi-target scenario to constitute effective item-related inputs.

Step 2, effective specific representations are extracted through the guidance of item scores to construct a hybrid encoder. Unlike conventional simple multiplications, the present disclosure guides item embedding by generating learnable weights based on scores.

In the step 2, the potential user uⱼ interacts in the X domain, and the corresponding history records include the specific item embedding

$${V}_{s}^{X} ∈ {R}^{N \times h}$$

and the score B^{X}∈R^{N×1}, where N is the sample size. To capture the domain representation, the present disclosure designs a hybrid network for compressing item embeddings and scores.

The present disclosure uses a hybrid network parameterized by Ψ, expressed as ƒ(·;Ψ): R^{N×h}→R^{1×h}, to encode item embedding, and a general mixing mechanism followed is as follows:

$${W}_{1} , {W}_{2} = \vert [ {W}_{{0}_{1}} , {W}_{{0}_{2}} ] \cdot B \vert ,$$

$$E = {W}_{2}^{T} \cdot ReLU ( {W}_{1}^{T} \cdot v ) ,$$

$$ℱ = E + {u}_{j} ,$$

where, W_{θ}_{₁} and W_{θ}_{₂} are learnable parameters, the symbol |·| represents taking the absolute value, and the mixing weights W₁∈R^{N×h} and W₂∈^{h×1} are obtained by learning based on the input score B.

After executing the above formula, a final encoded domain feature [symbol] ∈R^{1×h} is generated through a domain representation E and a current user embedding uⱼ. Here, the present disclosure uses two hybrid encoder branches to capture two encoded domain features.

Step 3, different encoded features are generated in a specific branch and a global branch.

In the step 3, in the specific branch, the input

$$[ {u}_{j} , ( {v}_{s}^{X} , {B}^{X} ) ]$$

is provided to a specific hybrid encoder, with an emphasis on capturing potential specific features. The specific encoded feature generated by the hybrid encoder is as follows:

$${ℱ}_{𝓈} = f ( [ {u}_{j} , ( {v}_{s}^{X} , {B}^{X} ) ] ; {ψ}_{S} ) ∈ {R}^{1 \times h}$$

In the step 3, in the global branch, the input [uⱼ, (v_{g}, B_{g})] is provided to the hybrid encoder to generate the global encoded feature, which is as follows:

$${ℱ}_{ℊ} = f ( [ {u}_{j} , ( {v}_{g} , {B}_{g} ) ] ; {ψ}_{g} ) ∈$$

In the step 3, the present disclosure uses a hybrid encoder to learn representations of the specific domain and global domain. The hybrid network can capture deeper level dependencies between items and further encode them as highly correlated domain-specific feature and global domain feature. These encoded features [ [symbol] , [symbol] ] will be further used by the decoder.

Step 4, dependency on irrelevant item features in the source domain is avoided, and focus is further placed on potential user preferences in the global domain. Preferences are represented by using prototypes, rather than using item features directly. At the core part of the prototype-aware decoder are quantified user interest prototypes to locate the target items, enabling the decoder to explicitly perceive user preferences.

In the step 4, the present disclosure divides the positive preferences into K adjustable prototypes and divides the negative preferences into K prototypes, and a total of 2K prototypes are present, thereby performing precise dislike-to-like quantification on preferences. The present disclosure expresses these prototypes as [symbol] ={p₁, p₂, . . . , p_{2K}|pᵢ∈R^{1×h}}. User preferences are extracted from the source domain, so they only interact with [symbol] . The model is allowed to perceive preferences by matching with the prototype p* with the highest similarity, and the specific similarity is calculated as follows:

$$sim ( {p}_{i} , {F}_{𝓈} ) = log ( \frac{{‖ {p}_{i} - {ℱ}_{𝓈} ‖}_{2}^{2} + 1}{{‖ {p}_{i} - {ℱ}_{𝓈} ‖}_{2}^{2} + ϵ} )$$

where, ϵ is set to a small value to prevent division by zero. After a preference prototype p* is obtained, such preferences of the source domain are introduced into the shared domain to guide the global encoded feature [symbol] , thereby effectively extracting a final user feature [symbol] from the target domain. The linear layer g^{u} is provided with the parameter ϕ used for dynamically adapting the encoded feature to the continuously changing preference features and extracting the final user feature:

$${ℱ}_{𝓊} = {g}_{u} ( {ℱ}_{ℊ} , p ⋆ ; ϕ ) ∈ {R}^{1 \times h}$$

The objective function [symbol] of prototype learning is defined as follows:

$${ℒ}_{𝓅ℓ} = {ℒ}_{𝒸ℯ} ( c ∘ {g}_{p} ∘ {ℱ}_{𝓈} , l ) + {λ}_{1} {ℒ}_{𝒸ℓ𝓈𝓉} + {λ}_{2} {L}_{𝓈ℯ𝓅} + {λ}_{3} {L}_{𝒹𝒾𝓋}$$

where, c denotes a fully connected layer and is used for predicting the probability of being positive or negative, and gₚ is the prototype layer. [symbol] represents the cross-entropy loss for preference classification within the prototype branch. When common interactive items are input, l is an array in which the values are all 1. λ₁ and λ₂ and λ₃ are weights for controlling loss, and the present disclosure may follow the general values in the classification task.

As shown in the formula above, to construct the final prototype, the present disclosure has correspondingly established the following constraints.

Clustering loss [symbol] encourages these interactive items within the source domain to approach a prototype corresponding to their preferences. Separation loss [symbol] facilitates an increase in the distance between the encoded item feature and the prototype that does not belong to its preferences.

$${ℒ}_{𝒸ℓ𝓈𝓉} = \frac{1}{n} {\sum }_{i = 1}^{2 K} {min}_{j : {p}_{j} ∈ {𝒫}_{{𝓎}_{𝒾}}} {‖ {ℱ}_{𝓈} - {p}_{j} ‖}_{2}^{2}$$

$${ℒ}_{𝓈ℯ𝓅} = - \frac{1}{n} {\sum }_{i = 1}^{2 K} {min}_{j : {p}_{j} ∉ {𝒫}_{{𝓎}_{𝒾}}} {‖ {ℱ}_{𝓈} - {p}_{j} ‖}_{2}^{2}$$

where, [symbol] is a set of prototypes under the class [symbol] . Furthermore, the diversity loss [symbol] in the above formula encourages diversity in the learned prototypes by punishing overly similar prototypes.

$${ℒ}_{𝒹𝒾𝓋} = {\sum }_{k = 1}^{2} {\sum }_{{i \neq j}_{{p}_{i} , {p}_{j} ∈ {𝒫}_{𝓀}}} max ( 0 , cos ( {p}_{i} , {p}_{j} ) - ξ )$$

where, k={1, 2} represents two preferences, and ξis the threshold for cosine similarity in the diversity loss.

Finally, a user-item prediction score is calculated by Sₚ= [symbol] ·vᵢ to decide which item to recommend.

The present disclosure follows the previous work and uses binary cross-entropy loss for basic prediction loss:

$${ℒ}_{{𝓅𝓇ℯ𝒹}^{}} = {\sum }_{( u , v ) ∈ ε} [ - log {S}_{p} - log ( 1 - {S}_{n} ) ]$$

where, the negative prediction score of an uninterested item v̅ⁱ is calculated through the dot product operation Sₙ= [symbol] ·v̅ⁱ.

Step 5, the present disclosure adopts contrastive learning as an auxiliary task algorithm to adjust the potential space of positive and negative interactions.

Assuming that on the K domain, the positive input is the same as the specific item

$${V}_{s}^{X}$$

on a primary branch. The negative input is randomly sampled from uninterested items

$${\overline{{V}_{s}}}^{X} .$$

After the primary branch, the positive feature

$${ℱ}_{p} = P P A ( {V}_{s}^{X} )$$

and the negative feature

$${ℱ}_{n} = PPA ( {\overline{{V}_{s}}}^{X} )$$

are obtained. The auxiliary loss is as follows:

$${ℒ}_{c ℓ}^{X} = {\sum }_{u ∈ 𝒰} x [ {ℒ}_{ce} ( {ℱ}_{𝓅} , {Z}_{p} ) + {ℒ}_{ce} ( {ℱ}_{𝓃} , {Z}_{n} )$$

where, [symbol] represents the cross-entropy loss for classification, Zₚ is a positive label and represents 1, and Zₙ is a negative label and represents 0. The whole model corresponding to the present disclosure can be optimized through the following overall objective function [symbol] :

$${ℒ}_{𝓉ℴ𝓉} = {ℒ}_{𝓅𝓇ℯ𝒹} + {λ}_{pl {ℒ}_{𝓅ℓ}} + {ℒ}_{c ℓ} .$$

### EXAMPLE

To validate the effectiveness of the method, in the present disclosure, experiments were conducted on the datasets corresponding to four different scenarios to make them accord with the experimental conditions of the present disclosure.

For the product recommendation task, the present disclosure used HitRatio (HR) and Normalized Discounted Cumulative Gain (NDCG) as evaluation criteria.

The present disclosure was compared with different contrast methods in four recommendation scenarios (intra-domain, inter-domain, multi-domain with overlapping items, and multi-domain with overlapping users). These four methods cover the majority of representative recommendation scenarios in general recommendation systems, demonstrating the universality of the model proposed by the present disclosure.

TABLE 1
Comparison of recommendation performance in an intra-domain recommendation scenario

| | | | | | | | | | | | Universal | |
|---|---|---|---|---|---|---|---|---|---|---|---|---|
| | | Single-Domain Methods | | | | Cross-Domain Methods | | | | | Methods | |
| Datasets | Metric@10 | BPRMF | NeuMF | NGCF | LightGCN | CoNet | DDTCDR | PPGN | Bi-TGCF | DisenCDR | UniCDR | Ours |
| Sport | HR | 10.43 | 10.74 | 13.13 | 13.19 | 12.09 | 11.86 | 15.10 | 14.83 | 17.55 | 18.37 | 20.72 |
| | NDCG | 5.41 | 5.46 | 6.87 | 6.94 | 6.41 | 6.37 | 8.03 | 7.95 | 9.46 | 10.98 | 14.25 |
| Cloth | HR | 11.53 | 11.18 | 13.22 | 13.58 | 12.40 | 12.54 | 14.23 | 14.68 | 16.31 | 17.85 | 19.92 |
| | NDCG | 6.25 | 6.02 | 6.97 | 7.29 | 6.62 | 7.13 | 7.68 | 7.93 | 9.03 | 11.20 | 13.89 |
| Elec | HR | 15.71 | 16.17 | 18.55 | 19.17 | 17.22 | 18.47 | 21.68 | 22.14 | 24.57 | 22.92 | 25.39 |
| | NDCG | 9.19 | 9.24 | 10.87 | 10.28 | 9.86 | 11.08 | 11.63 | 12.20 | 14.51 | 13.83 | 15.37 |
| Phone | HR | 16.32 | 15.84 | 22.79 | 23.25 | 17.66 | 17.23 | 24.54 | 25.71 | 28.76 | 24.72 | 31.30 |
| | NDCG | 8.53 | 8.02 | 12.38 | 12.72 | 9.30 | 8.58 | 13.34 | 13.93 | 16.13 | 13.77 | 17.86 |

TABLE 2
Comparison of recommendation performance in an inter-domain recommendation scenario

| | | | | | | | | | | Universal | |
|---|---|---|---|---|---|---|---|---|---|---|---|
| | | Single-Domain Methods | | | Cross-Domain Methods | | | | | methods | |
| Datasets | Metric@10 | CML | BPRMF | NGCF | EMCDR | SSCDR(CML) | TMCDR | SA-VAE | CDRIB | UniCDR | Ours |
| Sport | HR | 5.82 | 5.75 | 7.22 | 7.44 | 7.27 | 7.18 | 7.51 | 12.04 | 11.20 | 13.81 |
| | NDCG | 3.29 | 3.16 | 3.63 | 3.71 | 3.75 | 3.84 | 3.72 | 6.22 | 7.04 | 7.61 |
| Cloth | HR | 6.97 | 6.75 | 7.07 | 7.29 | 6.12 | 8.11 | 7.21 | 12.19 | 12.48 | 12.87 |
| | NDCG | 3.92 | 3.26 | 3.48 | 4.48 | 3.06 | 5.05 | 4.59 | 6.81 | 7.52 | 7.57 |
| Game | HR | 2.82 | 3.77 | 5.14 | 4.63 | 3.48 | 5.36 | 5.84 | 8.51 | 8.78 | 11.35 |
| | NDCG | 1.44 | 1.89 | 2.73 | 2.24 | 1.59 | 2.58 | 2.78 | 4.58 | 4.63 | 5.93 |
| Video | HR | 3.07 | 4.46 | 7.41 | 7.94 | 5.51 | 8.85 | 7.46 | 13.17 | 10.74 | 12.63 |
| | NDCG | 1.30 | 2.36 | 3.87 | 4.29 | 2.61 | 4.41 | 3.71 | 6.49 | 5.89 | 6.66 |

TABLE 3
Comparison of recommendation performance in recommendation in a scenario involving multiple domains with overlapping items

| | | Single-Domain Methods | | | | Cross-Domain Methods | | | | | | Universal | |
|---|---|---|---|---|---|---|---|---|---|---|---|---|---|
| | | | | Random | | Cross- | | Bi- | | | | Methods | |
| Datasets | Metric@10 | NeuMF | LightGCN | Walk | EASER | Stitch | MMoE | TGCF | STAR | FOREC | M3Rec | UniCDR | Ours |
| M1 | HR | 62.73 | 64.73 | 64.66 | 70.80 | 64.46 | 65.73 | 66.86 | 62.93 | 65.06 | 73.13 | 69.08 | 70.81 |
| | NDCG | 46.31 | 48.30 | 48.05 | 54.95 | 49.15 | 48.98 | 50.46 | 46.57 | 52.05 | 55.83 | 59.57 | 61.27 |
| M2 | HR | 55.60 | 52.13 | 50.20 | 57.40 | 54.06 | 56.26 | 53.46 | 54.89 | 58.42 | 60.86 | 58.01 | 58.76 |
| | NDCG | 34.84 | 32.70 | 31.10 | 37.92 | 36.65 | 38.71 | 33.43 | 35.25 | 40.03 | 40.04 | 47.52 | 48.74 |
| M3 | HR | 60.40 | 56.26 | 57.53 | 63.60 | 59.46 | 61.53 | 58.73 | 60.80 | 64.13 | 66.53 | 64.60 | 66.27 |
| | NDCG | 36.57 | 34.22 | 34.89 | 40.13 | 39.13 | 41.30 | 35.77 | 37.09 | 41.88 | 43.35 | 53.24 | 53.82 |
| M4 | HR | 40.33 | 41.14 | 39.20 | 45.13 | 38.93 | 38.60 | 42.26 | 40.20 | 41.60 | 48.46 | 47.52 | 48.61 |
| | NDCG | 29.83 | 31.03 | 30.08 | 36.63 | 29.16 | 30.16 | 32.76 | 29.84 | 33.52 | 37.98 | 42.54 | 42.69 |
| M5 | HR | 12.26 | 17.13 | 17.73 | 19.13 | 17.06 | 16.66 | 17.86 | 16.60 | 17.46 | 22.66 | 19.78 | 20.92 |
| | NDCG | 9.01 | 13.16 | 14.07 | 16.93 | 12.51 | 11.79 | 14.42 | 12.48 | 13.19 | 18.63 | 17.04 | 17.38 |

TABLE 4
Comparison of recommendation performance in recommendation in a scenario involving multiple domains with overlapping users

| | | | | | | | | | | | Universal | |
|---|---|---|---|---|---|---|---|---|---|---|---|---|
| | | Single-Domain Methods | | | | Cross-Domain Methods | | | | | Methods | |
| Datasets | Metric@10 | BPRMF | NeuMF | EASER | LightGCN | MMoE | CoNet | Bi-TGCF | GA-MTCDR | HeroGraph | UniCDR | Ours |
| D1 | HR | 19.48 | 20.57 | 9.15 | 25.52 | 21.22 | 20.60 | 26.98 | 26.13 | 29.73 | 32.60 | 36.07 |
| | NDCG | 7.66 | 7.17 | 4.04 | 10.60 | 8.82 | 8.46 | 10.64 | 10.02 | 11.74 | 13.56 | 15.26 |
| D2 | HR | 50.45 | 52.92 | 50.07 | 56.18 | 56.22 | 53.53 | 60.48 | 59.59 | 61.49 | 64.37 | 62.91 |
| | NDCG | 33.50 | 35.73 | 28.53 | 37.09 | 38.63 | 37.66 | 47.19 | 47.67 | 49.57 | 50.48 | 50.78 |
| D3 | HR | 64.87 | 64.53 | 50.40 | 67.13 | 65.71 | 65.90 | 72.88 | 73.32 | 71.77 | 73.89 | 74.08 |
| | NDCG | 47.69 | 48.44 | 29.02 | 40.49 | 47.08 | 47.51 | 54.15 | 57.00 | 56.81 | 59.15 | 59.61 |

Specifically, Table 1, Table 2, Table 3, and Table 4 show the experimental results under four representative recommendation scenarios for universal recommendation. It can be seen that in these four scenarios, the method proposed in the present disclosure exhibits excellent performance in terms of both HR and NDCG metrics, demonstrating superior performance in the domain of universal recommendation.

1. A universal cross-domain recommendation method based on preference prototype-aware learning, comprising: quantifying user preferences through prototype-aware learning and realizing universal cross-domain recommendations under several scenarios according to given specific interactive items, global interactive items, and user IDs, and steps of the method comprise:
S1, defining users, items, and interactions in domains, wherein a dual-domain scenario composed of an X domain and a Y domain is expressed as i∈{X, Y}, a set of the users, the items, and the interactions is expressed as [symbol] =( [symbol] , [symbol] , [symbol] ), and a similarity score between cross-domain items is expressed as B_{g}=(B^{X}, B^{Y}), wherein B^{X} and B^{Y} represent personalized similarity scores in the X domain and the Y domain, respectively, and the similarity scores are used for enhancing prior knowledge of item features;
based on an interaction [symbol] , N items are selected from items [symbol] to constitute a specific interactive item Vₛⁱ; based on the interaction [symbol] , 2N items are selected from [symbol] and [symbol] to represent a shared interactive item V_{g}; Vₛⁱ and Bⁱ, as well as global embeddings V_{g} and B_{g}, constitute effective item-related inputs;
S2, extracting effective specific representations through guidance of item scores to construct a hybrid encoder, learning universal representations of interacted items based on a hybrid network, and capturing two encoded domain features via two hybrid encoder branches, so as to capture deeper level dependencies between the items and generate learnable weights through the item scores to guide item embeddings;
considering interaction behaviors of a potential user uⱼ within the X domain, the hybrid network is designed based on history records containing a specific item embedding [symbol] and a score B^{X}∈R^{N×1} to capture a domain representation E, and the hybrid network is used for compressing item embeddings and scores, wherein N is a sample volume;
the hybrid network encodes the item embeddings through a parameter Ψ, and encoding is expressed as ƒ(·; Ψ):R^{N×h}→R^{1×h}; the hybrid network follows the following mixing mechanism: [symbol]
wherein, W_{θ}_{₁} and W_{θ}_{₂} are learnable parameters, a symbol |·| represents taking an absolute value, and mixing weights W₁∈R^{N×h} and W₂∈R^{h×1} are obtained by learning based on an input score B;
after executing above formula, a final encoded domain feature [symbol] ∈R^{1×h} is generated through the domain representation E and a current user embedding uⱼ;
S3, based on a relationship between items captured by the hybrid network in the step S2, encoding a specific branch and a global branch into a specific domain feature and a global domain feature that are highly relevant, then learning representations of a specific domain and a global domain by using the hybrid encoder, and providing representations and encoded features of the specific branch and the global branch for a prototype-aware decoder; and
S4, using a user interest prototype quantified by a prototype decoder to locate a target item, including performing dislike-to-like quantification on the user preferences in a source domain according to a positive preference and a negative preference, thereby obtaining a prototype preference representation; calculating item similarity based on the prototype-aware decoder, and introducing preferences of the source domain into a shared domain to guide a global encoded feature [symbol] to realize extraction of a final user feature from a target domain; and finally determining a recommended item through calculation of user-item prediction scores through Sₚ= [symbol] ·vᵢ;
the method comprises adopting contrastive learning as an auxiliary task algorithm to adjust potential space of positive and negative interactions.

2. The universal cross-domain recommendation method based on the preference prototype-aware learning according to claim 1, wherein the step S1 further comprises the following step:
defining [symbol] ∈ [symbol] and [symbol] ∈ [symbol] as embeddings of the users and the items, respectively, for extracting effective representations, wherein h is a global embedding dimension, u represents an embedding of a data user, and three basic representations, u, (Vₛⁱ, Bⁱ), and (V_{g}, B_{g}), that are capable of being applied to cross-domain recommendation in a multi-target scenario are obtained based on an embedding layer, wherein u represents a user embedding, vₛⁱ represents a specific item embedding with score Bⁱ, and V_{g} represents a global item embedding with score B_{g}.

3. (canceled)

4. The universal cross-domain recommendation method based on the preference prototype-aware learning according to claim 1, wherein in the step S3, the specific branch refers to feeding an input [uⱼ, (vₛ^{X}, B^{X})] to the hybrid encoder to capture a potential specific feature, and specific feature is expressed as follows:
$${ℱ}_{𝓈} = f ( [ {u}_{j} , ( {v}_{s}^{X} , {B}^{X} ) ] ; {ψ}_{s} ) ∈ {R}^{1 \times h}$$
the global branch refers to feeding an input [uⱼ, (v_{g}, B_{g})] to the hybrid encoder to generate the global encoded feature, and the global encoded feature is expressed as follows:
$${ℱ}_{ℊ} = f ( [ {u}_{j} , ( {v}_{g} , {B}_{g} ) ] ; {ψ}_{g} ) ∈ {R}^{𝟙 \times h}$$
in this step, the encoded features [ [symbol] , [symbol] ] will be further used by a decoder.

5. The universal cross-domain recommendation method based on the preference prototype-aware learning according to claim 1, wherein in the step S4, the quantification of the user preferences in the source domain is dividing the positive preference into K adjustable prototypes and dividing the negative preference into K prototypes and thereby enabling quantification of preferences, ranging from dislike to like;
above prototypes are expressed as [symbol] ={p₁, p₂, . . . , p_{2K}|pᵢ∈R^{1×h}}, and as the user preferences are extracted from the source domain, prototypes interact only with [symbol] , so a model is allowed to perceive preferences by matching with a prototype p* with a highest similarity, and similarity is calculated as follows:
$$sim ( {p}_{i} , {ℱ}_{𝓈} ) = log ( \frac{{‖ {p}_{i} - {ℱ}_{𝓈} ‖}_{2}^{2} + 1}{{‖ {p}_{i} - {ℱ}_{𝓈} ‖}_{2}^{2} + ϵ} )$$
wherein, ϵ is set to any small value to prevent division by zero; after preference prototype p* is obtained, such preferences of the source domain are introduced into the shared domain to guide the global encoded feature [symbol] , thereby effectively extracting the final user feature [symbol] from the target domain, wherein a linear layer gᵤ is provided with a parameter ϕ used for dynamically adapting the encoded feature to continuously changing preference features and extracting the final user feature:
$${ℱ}_{𝓊} = {g}_{u} ( {ℱ}_{ℊ} , {p}^{*} ; ϕ ) ∈ {R}^{1 \times h}$$
an objective function [symbol] of prototype learning is defined as follows:
$${ℒ}_{𝓅ℓ} = {ℒ}_{𝒸ℯ} ( c ∘ {g}_{p} ∘ {ℱ}_{𝓈} , l ) + {λ}_{1} {ℒ}_{𝒸 ℓ𝓈𝓉} + {λ}_{2} {ℒ}_{𝓈ℯ𝓅} + {λ}_{3} {ℒ}_{𝒹𝒾𝓋}$$
wherein, c denotes a fully connected layer and is used for predicting probability of being positive or negative, gₚ is a prototype layer, [symbol] represents cross-entropy loss for preference classification within a prototype branch, l is an array for distinguishing item types, and λ₁ and λ₂ and λ₃ are weights for controlling loss;
to construct a final prototype, constraints considered comprise:
(1) setting a clustering loss [symbol] to encourage these interactive items of the source domain to approach a prototype corresponding to preferences thereof;
$${L}_{c ℓ𝓈𝓉} = \frac{1}{n} {\sum }_{i = 1}^{2 K} {min}_{j : {p}_{j} ∈ {𝒫}_{{𝓎}_{𝒾}}} {‖ {ℱ}_{𝓈} - {p}_{j} ‖}_{2}^{2}$$
(2) setting a separation loss [symbol] to facilitate an increase in a distance between an encoded item feature and a prototype that does not belong to preferences thereof; and
$${ℒ}_{𝓈ℯ𝓅} = - \frac{1}{n} {\sum }_{i = 1}^{2 K} {min}_{j : {p}_{j} ∉ {𝒫}_{{𝓎}_{𝒾}}} {‖ {ℱ}_{𝓈} - {p}_{j} ‖}_{2}^{2}$$
(3) setting a diversity loss [symbol] to encourage diversity in learned prototypes by punishing overly similar prototypes;
$${ℒ}_{𝒹𝒾𝓋} = {\sum }_{k = 1}^{2} {\sum }_{{i \neq j}_{{p}_{i} , {p}_{j} ∈ {𝒫}_{𝓀}}} max ( 0 , cos ( {p}_{i} , {p}_{j} ) - ξ )$$
in above formula, [symbol] , is a set of prototypes under class [symbol] , k={1, 2} represents two preferences, and ξ is a threshold for cosine similarity in the diversity loss;
finally, the user-item prediction score is calculated through Sₚ= [symbol] ·vᵢ to determine the recommended item;
the method also uses binary cross-entropy loss to make a prediction of loss:
$${ℒ}_{𝓅𝓇ℯ𝒹} = {\sum }_{( u , v ) ϵℰ} [ - log {S}_{p} - log ( 1 - {S}_{n} ) ]$$
wherein, a negative prediction score of an uninterested item v̅ⁱ is calculated through a dot product operation Sₙ= [symbol] ·v̅ⁱ.

6. (canceled)
